(19) United States
(12) Patent Application Publication
(10) Pub. No.: US 2026/0027709 A1
(43) Pub. Date: Jan. 29, 2026

(54) INFORMATION PROCESSING APPARATUS, ROBOT SYSTEM, AND INFORMATION PROCESSING METHOD

(71) Applicant: SEIKO EPSON CORPORATION, Tokyo (JP)

(72) Inventors: Kazushige NISHIMORI, AZUMINO-SHI (JP); Shunichi MIZUOCHI, MATSUMOTO-SHI (JP)

(21) Appl. No.: 19/275,827

(22) Filed: Jul. 21, 2025

(30) Foreign Application Priority Data
Jul. 24, 2024 (JP) 2024-118930

(51) Int. Cl. B25J 9/16; B25J 9/04

(52) U.S. Cl. CPC B25J 9/1653; B25J 9/042

(57) ABSTRACT

An information processing apparatus includes a first memory, a determination unit that determines whether a predetermined trigger condition occurs, a writing unit, a transmission unit, and a third memory. The writing unit writes second specific operational information stored in the third memory to a second memory after the transmission unit completes transmission of first specific operational information.

### CROSS-REFERENCE TO RELATED APPLICATIONS

The present application is based on, and claims priority from JP Application Serial Number 2024-118930, filed Jul. 24, 2024, the disclosure of which is hereby incorporated by reference herein in its entirety.

### BACKGROUND OF THE INVENTION

### 1. Technical Field

The present disclosure relates to an information processing apparatus, a robot system, and an information processing method.

### 2. Related Art

In recent years, automation of work that has been performed manually has been accelerated by various robots and their peripheral devices due to soaring labor costs and shortage of human resources in factories. In such a robot, it is known to store operational information of the robot using a robot control apparatus as described in JP-A-2015-112631. This enables analysis of the operational information of the robot when an error occurs, allowing identification of the cause, degree, and the like of the error.

The robot control apparatus described in JP-A-2015-112631 includes a first storage unit that stores operational information pertaining to a fixed time period in real time, a second storage unit that extracts and stores operational information corresponding to an error from the operational information stored in the first storage unit when the error occurs, and a transmission unit that backs up the operational information stored in the second storage unit.

The first storage unit includes a ring buffer, and temporarily stores operational information, deletes the operational information after a predetermined time period has elapsed, and stores new operational information. The transmission unit transmits the operational information stored in the second storage unit to outside at a predetermined timing.

However, in JP-A-2015-112631, since the first storage unit includes the ring buffer, data is deleted after a fixed time period has elapsed. For this reason, when multiple errors, for example, two errors occur at different times, the following inconvenience occurs. When the second error occurs while backup is being performed by storing operational information related to the first error in the second storage unit and transmitting the operational information stored in the second storage unit to an external apparatus, operational information related to the second error is stored in the second storage unit after the backup is completed. That is, when a new error occurs during backup, data related to the newly occurred error cannot be saved from the first storage unit to the second storage unit until the backup is completed. Waiting until the backup is completed may cause necessary data in the first storage unit, that is, the operational information related to the second error, to be overwritten and erased, or all or part of the data to be lost or damaged.

### SUMMARY OF THE INVENTION

The information processing apparatus of the present disclosure includes a first memory that stores operational information pertaining to a fixed time period in real time while a robot having a robot arm is operating; a determination unit that determines whether a predetermined trigger condition occurs; a writing unit that, when the determination unit determines that the trigger condition occurs, extracts first specific operational information corresponding to a cause of the trigger condition from the operational information stored in the first memory, and writes the first specific operational information to a second memory; a transmission unit that transmits the first specific operational information stored in the second memory to outside of the second memory; and a third memory that, when the determination unit determines that another trigger condition occurs before the transmission unit completes transmission of the first specific operational information, stores second specific operational information extracted from the operational information by the writing unit, the second specific operational information corresponding to a cause of the other trigger condition. The writing unit writes the second specific operational information stored in the third memory to the second memory after the transmission unit completes transmission of the first specific operational information.

The robot system of the present disclosure includes a robot having a robot arm; and an information processing apparatus that processes operational information of the robot. The information processing apparatus includes a first memory that stores operational information pertaining to a fixed time period in real time; a determination unit that determines whether a predetermined trigger condition occurs; a writing unit that, when the determination unit determines that the trigger condition occurs, extracts first specific operational information corresponding to a cause of the trigger condition from the operational information stored in the first memory, and writes the first specific operational information to a second memory; a transmission unit that transmits the first specific operational information stored in the second memory to outside of the second memory; and a third memory that, when the determination unit determines that another trigger condition occurs before the transmission unit completes transmission of the first specific operational information, stores second specific operational information extracted from the operational information by the writing unit, the second specific operational information corresponding to a cause of the other trigger condition. The writing unit writes the second specific operational information stored in the third memory to the second memory after the transmission unit completes transmission of the first specific operational information.

The information processing method of the present disclosure includes a first step of writing operational information pertaining to a fixed time period of a robot having a robot arm to a first memory that stores the operational information in real time; a second step of determining whether a predetermined trigger condition occurs; a third step of, when it is determined in the second step that the trigger condition occurs, writing first specific operational information corresponding to a cause of the trigger condition, of the operational information stored in the first memory, to a second memory; a fourth step of transmitting the first specific operational information stored in the second memory to outside of the second memory; a fifth step of, when another trigger condition occurs before transmission of the first specific operational information in the fourth step is completed, extracting second specific operational information corresponding to a cause of the other trigger condition from the operational information and storing the second specific operational information in a third memory; and a sixth step of writing the second specific operational information stored in the third memory to the second memory after transmission of the first specific operational information is completed.

### BRIEF DESCRIPTION OF DRAWINGS

FIG. 1 is a diagram illustrating an overall configuration of a robot system according to an embodiment of the present disclosure.

FIG. 2 is a block diagram of the robot system illustrated in FIG. 1.

FIG. 3 is a functional block diagram of an information processing apparatus included in the robot system illustrated in FIG. 1.

FIG. 4 is a schematic diagram for explaining a state in which operational information is written to a first memory and a state in which first specific operational information stored in the first memory is written to a second memory when a trigger condition occurs in the information processing apparatus.

FIG. 5 is a schematic diagram for explaining a state in which the first specific operational information stored in the second memory is written to the outside of the second memory in the information processing apparatus.

FIG. 6 is a schematic diagram for explaining a state in which second specific operational information stored in the first memory is written to a third memory when a trigger condition occurs in the information processing apparatus.

FIG. 7 is a schematic diagram for explaining a state in which the second specific operational information stored in the third memory is written to the second memory in the information processing apparatus.

FIG. 8 is a flowchart for explaining an example of the information processing apparatus and an information processing method of the present disclosure.

### DETAILED DESCRIPTION OF THE INVENTION

### Embodiment

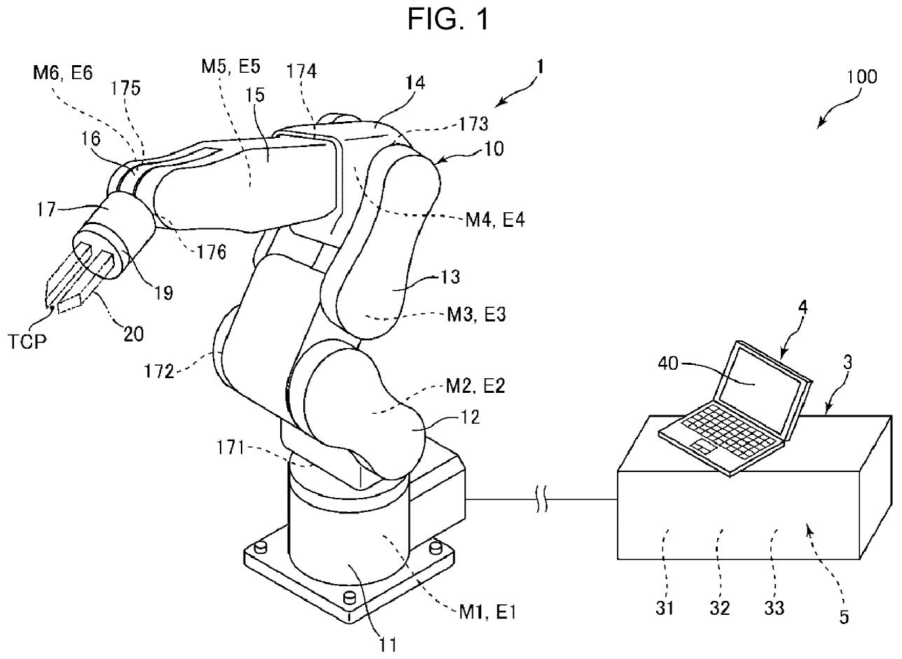

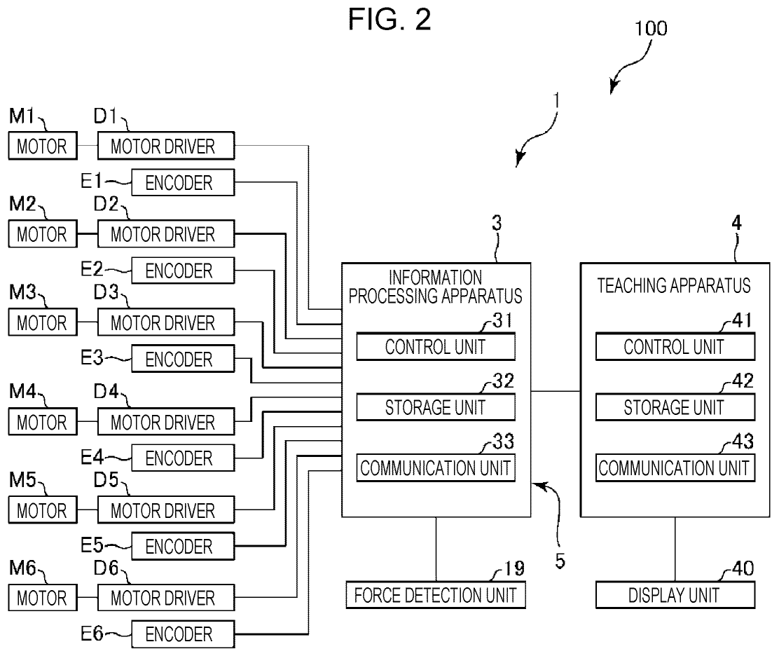

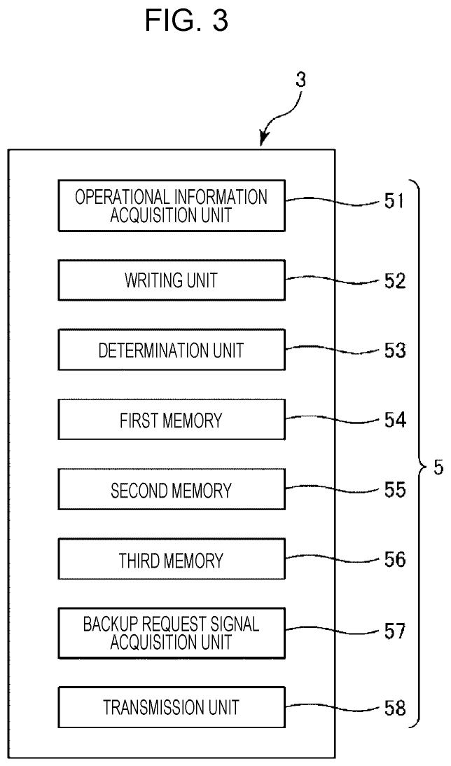

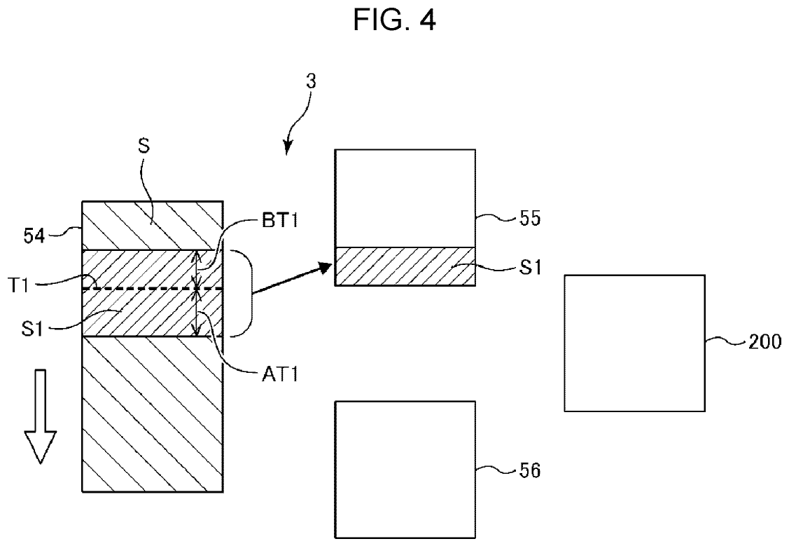

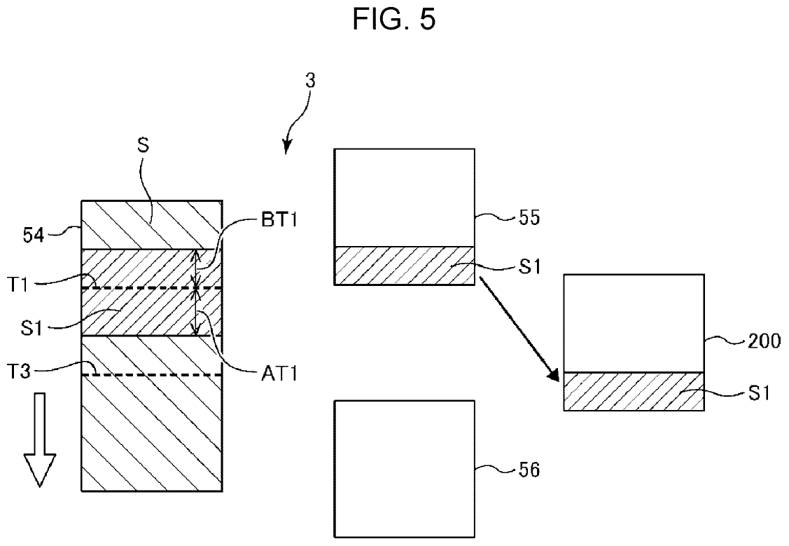

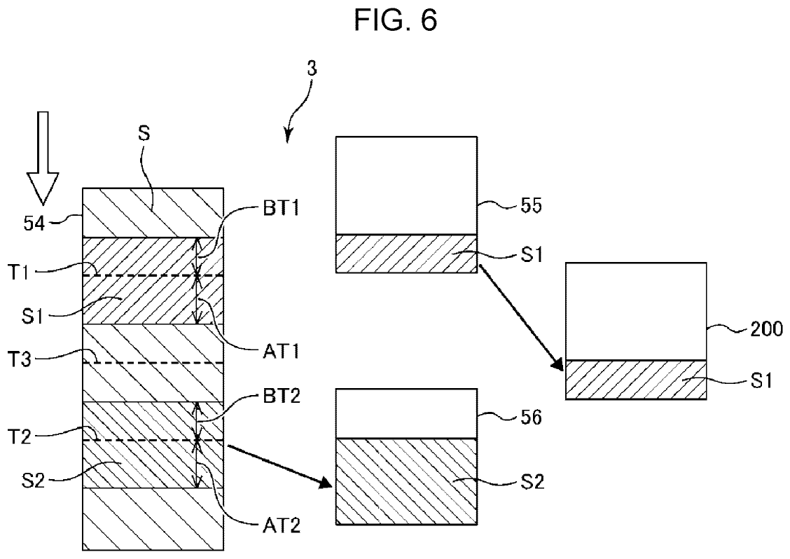

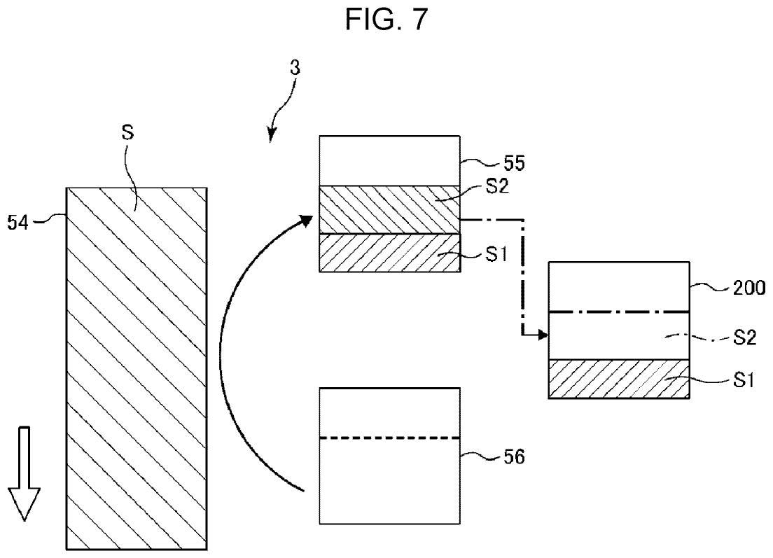

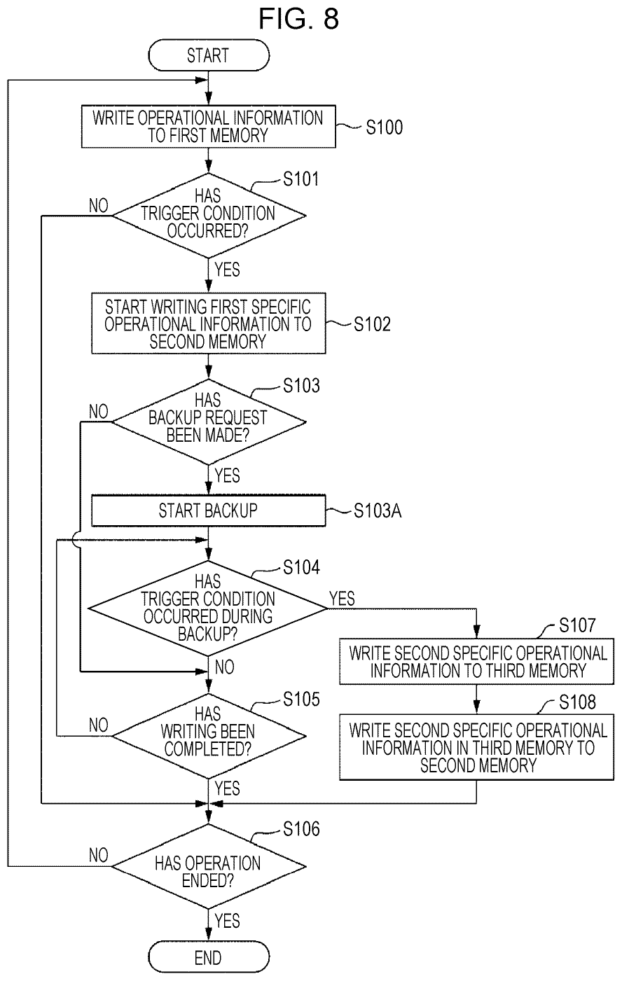

FIG. 1 is a diagram illustrating an overall configuration of a robot system according to an embodiment of the present disclosure. FIG. 2 is a block diagram of the robot system illustrated in FIG. 1. FIG. 3 is a functional block diagram of an information processing apparatus included in the robot system illustrated in FIG. 1. FIG. 4 is a schematic diagram for explaining a state in which operational information is written to a first memory and a state in which first specific operational information stored in the first memory is written to a second memory when a trigger condition occurs in the information processing apparatus. FIG. 5 is a schematic diagram for explaining a state in which the first specific operational information stored in the second memory is written to the outside of the second memory in the information processing apparatus. FIG. 6 is a schematic diagram for explaining a state in which second specific operational information stored in the first memory is written to a third memory when a trigger condition occurs in the information processing apparatus. FIG. 7 is a schematic diagram for explaining a state in which the second specific operational information stored in the third memory is written to the second memory in the information processing apparatus. FIG. 8 is a flowchart for explaining an example of the information processing apparatus and an information processing method of the present disclosure.

Hereinafter, the information processing apparatus, the robot system, and the information processing method of the present disclosure will be described in detail on the basis of preferred embodiments illustrated in the accompanying drawings. For convenience of description, in a robot arm, a base 11 side in FIG. 1 is also hereinafter referred to as a “proximal end”, and the opposite side, that is, an end effector 20 side, is also hereinafter referred to as a “distal end”.

As illustrated in FIGS. 1 and 2, a robot system 100 includes a robot 1, an information processing apparatus 3 having a function of processing operational information of the robot 1, and a teaching apparatus 4.

First, the robot 1 will be described.

The robot 1 illustrated in FIG. 1 is a single-arm six-axis vertical articulated robot in the present embodiment and includes a base 11 and a robot arm 10. Also, an end effector 20 can be attached to the distal end portion of the robot arm 10. The end effector 20 may be a constituent element of the robot 1 or may not be a constituent element of the robot 1.

Note that the robot 1 is not limited to the illustrated configuration, and may be, for example, a double-arm articulated robot. Furthermore, the robot 1 may be a horizontal articulated robot.

The base 11 is a support body that supports the robot arm 10 from the lower side in FIG. 1 such that the robot arm 10 can be driven, and is fixed to, for example, a floor in a factory. In the robot 1, the base 11 is electrically connected to the information processing apparatus 3 via a relay cable. Note that the connection between the robot 1 and the information processing apparatus 3 is not limited to a wired connection as in the configuration illustrated in FIG. 1, and may be, for example, a wireless connection or a connection via a network such as the Internet.

In the present embodiment, the robot arm 10 includes a first arm 12, a second arm 13, a third arm 14, a fourth arm 15, a fifth arm 16, and a sixth arm 17, and these arms are joined in this order from the base 11 side. Note that the number of arms included in the robot arm 10 is not limited to six, and may be, for example, one, two, three, four, five, or seven or more. Further, the size such as the total length of each arm is not particularly limited, and can be appropriately set.

The base 11 and the first arm 12 are joined via a joint 171. The first arm 12 is rotatable with respect to the base 11 about a first rotation axis that is parallel to the vertical direction. The first rotation axis coincides with a normal line of the floor to which the base 11 is fixed.

The first arm 12 and the second arm 13 are joined via a joint 172. The second arm 13 is rotatable with respect to the first arm 12 about a second rotation axis that is parallel to the horizontal direction. The second rotation axis is parallel to an axis that is orthogonal to the first rotation axis.

The second arm 13 and the third arm 14 are joined via a joint 173. The third arm 14 is rotatable with respect to the second arm 13 about a third rotation axis that is parallel to the horizontal direction. The third rotation axis is parallel to the second rotation axis.

The third arm 14 and the fourth arm 15 are joined via a joint 174. The fourth arm 15 is rotatable with respect to the third arm 14 about a fourth rotation axis that is parallel to the central axial direction of the third arm 14. The fourth rotation axis is orthogonal to the third rotation axis.

The fourth arm 15 and the fifth arm 16 are joined via a joint 175. The fifth arm 16 is rotatable with respect to the fourth arm 15 about a fifth rotation axis. The fifth rotation axis is orthogonal to the fourth rotation axis.

The fifth arm 16 and the sixth arm 17 are joined via a joint 176. The sixth arm 17 is rotatable with respect to the fifth arm 16 about a sixth rotation axis. The sixth rotation axis is orthogonal to the fifth rotation axis.

In addition, the sixth arm 17 is a robot distal end portion positioned at the most distal end side of the robot arm 10. The sixth arm 17 can be rotated together with the end effector 20 by driving the robot arm 10.

The robot 1 includes motors M1, M2, M3, M4, M5, and M6 as drive units, and encoders E1, E2, E3, E4, E5, and E6. The motor M1 is built into the joint 171 and rotates the base 11 and the first arm 12 relative to each other. The motor M2 is built into the joint 172 and rotates the first arm 12 and the second arm 13 relative to each other. The motor M3 is built into the joint 173 and rotates the second arm 13 and the third arm 14 relative to each other. The motor M4 is built into the joint 174 and rotates the third arm 14 and the fourth arm 15 relative to each other. The motor M5 is built into the joint 175 and rotates the fourth arm 15 and the fifth arm 16 relative to each other. The motor M6 is built into the joint 176 and rotates the fifth arm 16 and the sixth arm 17 relative to each other.

In addition, the encoder E1 is built into the joint 171 and detects the position of the motor M1. The encoder E2 is built into the joint 172 and detects the position of the motor M2. The encoder E3 is built into the joint 173 and detects the position of the motor M3. The encoder E4 is built into the joint 174 and detects the position of the motor M4. The encoder E5 is built into the fifth arm 16 and detects the position of the motor M5. The encoder E6 is built into the sixth arm 17 and detects the position of the motor M6.

The encoders E1 to E6 are electrically connected to the information processing apparatus 3, and the position information of the motors M1 to M6, that is, the amount of rotation, is transmitted to the information processing apparatus 3 as an electric signal. On the basis of the position information, the information processing apparatus 3 drives the motors M1 to M6 via motor drivers D1 to D6. That is, controlling the robot arm 10 means controlling the motors M1 to M6.

In addition, in the robot 1, a force detection unit 19 that detects stress applied to the robot arm 10 is installed at the distal end portion of the robot arm 10. The robot arm 10 can be driven in a state where the force detection unit 19 is installed. In the present embodiment, the force detection unit 19 is a six-axis force sensor. That is, the force detection unit 19 is a torque sensor that detects the magnitudes of forces along three detection axes orthogonal to each other and the magnitudes of torques around the three detection axes. The force detection unit 19 is not limited to the six-axis force sensor, and may have another configuration.

The end effector 20 can be detachably attached to the force detection unit 19. In the present embodiment, the end effector 20 includes a hand with a pair of claw portions capable of approaching and separating from each other. The hand grips and releases a work object with the claw portions. Note that the end effector 20 is not limited to the illustrated configuration, and may be a hand that grips a work object by suction. Also, the end effector 20 may be, for example, a polishing machine, a grinding machine, a cutting machine, or a tool such as a screwdriver or a wrench.

Also, in a robot coordinate system, a control point TCP is set at the distal end of the end effector 20. In the robot system 100, the control point TCP can be used as a reference for control by ascertaining the position of the control point TCP in the robot coordinate system.

Next, the teaching apparatus 4 will be described.

As illustrated in FIGS. 1 and 2, the teaching apparatus 4 includes a display unit 40 and has a function of creating an operation program for the robot arm 10 or inputting an operation program to the robot arm 10. The teaching apparatus 4 is not particularly limited, and examples thereof include a tablet, a personal computer, a smartphone, and a teaching pendant.

Specifically, the teaching apparatus 4 includes a control unit 41, a storage unit 42, and a communication unit 43.

The control unit 41 includes, for example, a central processing unit (CPU), and reads various programs such as a teaching program stored in the storage unit 42 and the like.

The storage unit 42 stores various programs and the like executable by the control unit 41. Examples of the storage unit 42 include a volatile memory such as a random-access memory (RAM), a non-volatile memory such as a read-only memory (ROM), and a detachable external storage device.

The communication unit 43 transmits and receives signals to and from the information processing apparatus 3 using an external interface such as a wired local area network (LAN) or a wireless LAN.

Next, the information processing apparatus 3 will be described.

As illustrated in FIGS. 1, 2, and 3, the information processing apparatus 3 has a function of acquiring and storing operational information of the robot 1 and a function of controlling the operation of the robot 1. In this sense, the information processing apparatus 3 can also be referred to as a robot control apparatus having a function of storing operational information of the robot 1.

The information processing apparatus 3 may not have the function of controlling the operation of the robot 1. In this case, a robot control apparatus is provided separately from the information processing apparatus 3.

As illustrated in FIG. 1, in the present embodiment, the information processing apparatus 3 is installed at a position away from the robot 1. However, the information processing apparatus 3 is not limited to this configuration, and for example, may be built into the base 11 of the robot 1.

As illustrated in FIG. 2, the information processing apparatus 3 includes a control unit 31, a storage unit 32, and a communication unit 33. These units are communicably connected to each other via, for example, a bus.

The control unit 31 includes, for example, a central processing unit (CPU), and reads and executes various programs such as an operation program stored in the storage unit 32. A signal generated by the control unit 31 is transmitted to each portion of the robot 1 via the communication unit 33. In this way, the robot arm 10 can execute a predetermined operation under predetermined conditions.

The storage unit 32 stores various programs and the like executable by the control unit 31. Examples of the storage unit 32 include a volatile memory such as a random-access memory (RAM), a non-volatile memory such as a read-only memory (ROM), and a detachable external storage device. The storage unit 32 stores a program for executing the information processing method of the present disclosure. However, the program for executing the information processing method of the present disclosure is not limited to this configuration, and may be stored in a storage device other than the storage unit 32, for example, the storage unit 42 of the teaching apparatus 4, a server 200, or the like.

The communication unit 33 transmits and receives signals to and from the robot 1 using an external interface such as a wired local area network (LAN) or a wireless LAN.

In the robot system 100, the information processing apparatus 3 acquires data constituting operational information regarding the operation of the robot 1 (hereinafter, referred to as “operational information S”) in real time as necessary and stores the acquired operational information S as necessary. The operational information S of the robot 1 includes stress information regarding the stress applied to the robot arm 10 and velocity information regarding the velocity of the robot arm 10.

The stress information regarding the stress applied to the robot arm 10 is obtained on the basis of the detection value of the force detection unit 19. That is, the stress information regarding the stress applied to the robot arm 10, in particular, the stress information regarding the stress applied to the distal end portion (control point TCP) of the robot arm 10, includes the values of forces along three detection axes orthogonal to each other set in the force detection unit 19 and the values of torques around the three detection axes.

The stress information regarding the stress applied to the robot arm 10 is not limited to the above-described configuration, that is, not limited to including the detection value of the force detection unit 19. The stress information regarding the stress applied to the robot arm 10 may be, for example, stress information detected by a force detection unit (not illustrated) similar to the force detection unit 19, installed in the base 11 or each of the joints 171 to 176.

In addition, the stress information regarding the stress applied to the robot arm 10 is not limited to the information obtained by the force detection unit 19 or the like, and may include the detection value of another sensor, for example, a vibration sensor, an inertial sensor, or the like.

The velocity information regarding the velocity of the robot arm 10 is information regarding the velocity of the control point TCP. The velocity of the control point TCP can be obtained from the respective rotational speeds of the joints 171, 172, 173, 174, 175, and 176. The respective rotational speeds of the joints 171, 172, 173, 174, 175, and 176 can be obtained from the detection values of the encoders E1, E2, E3, E4, E5, and E6. That is, the detection values of the encoders E1, E2, E3, E4, E5, and E6 can be regarded as the velocity information regarding the velocity of the robot arm 10.

The velocity information regarding the velocity of the robot arm 10 is not limited to the above-described configuration, and may include velocity information regarding the velocity of a portion other than the control point TCP, for example, a predetermined portion of each arm constituting the robot arm 10.

Further, the velocity information regarding the velocity of the robot arm 10 may be information obtained by calculation from an imaging result of a camera (not illustrated) or may be information obtained by calculation from the detection value of a velocity sensor (not illustrated).

In addition, when the velocity of the control point TCP can be calculated from the detection value of the force detection unit 19, the calculated value may be used as the velocity information regarding the velocity of the robot arm 10 (control point TCP).

The information processing apparatus 3 acquires the above-described operational information S and performs processing described below. This will be described below.

As illustrated in FIG. 3, the information processing apparatus 3 includes, as a functional unit 5, an operational information acquisition unit 51, a writing unit 52, a determination unit 53, a first memory 54, a second memory 55, a third memory 56, a backup request signal acquisition unit 57, and a transmission unit 58. When the backup request signal acquisition unit 57 acquires (receives) a backup request signal described later, the transmission unit 58 transmits first specific operational information S1 stored in the second memory 55 to the outside of the second memory 55. The functional unit 5 can be realized by the hardware configuration example illustrated in FIG. 2.

The operational information acquisition unit 51 acquires operational information S as described above from each portion of the robot 1 in real time while the robot arm 10 is operating.

As illustrated in FIGS. 3, 4, 5, 6, and 7, the writing unit 52 has a function of writing operational information S acquired by the operational information acquisition unit 51 to the first memory 54 (normal write function), a function of writing first specific operational information S1 described later to the second memory 55 (hereinafter referred to as a “first write function”), a function of writing second specific operational information S2 described later to the third memory 56 (hereinafter referred to as a “second write function”), and a function of writing the second specific operational information S2 stored in the third memory 56 to the second memory 55 (hereinafter referred to as a “third write function”). The functions may be performed by one processor or may be performed by a plurality of different processors. When the functions are performed by a plurality of different processors, these processors are collectively referred to as the writing unit 52.

The writing of information by the writing unit 52 means that the memory to which information has been written stores the information as data in a predetermined format. In addition, the writing of information by the writing unit 52 may be either duplication of data constituting information or deletion and movement of data constituting originally existing information. In the following description, it will be explained as duplication of data constituting information.

The first memory 54 is a storage device provided in the information processing apparatus 3, and includes a volatile memory such as a so-called ring buffer. That is, the first memory 54 stores operational information S pertaining to a fixed time period (hereinafter, described as 30 seconds) in real time, and when a fixed time period has elapsed, overwrites the old operational information S with new operational information S.

In FIG. 4, the first memory 54 is indicated by a rectangle, and the inside of the rectangle is the area for storing information. As indicated by an arrow in FIG. 4, operational information S is written in real time from the upper side toward the lower side inside the rectangle. When the entire area inside the rectangle is, for example, an area for storing operational information S pertaining to 30 seconds, the operational information S is stored from a 0-second mark (the upper end of the rectangle) toward the lower side. After the operational information S pertaining to 30 seconds is stored, the operational information S (old operational information S) is then overwritten sequentially from the operational information S at the 0-second mark (upper end of the rectangle). The writing unit 52 performs the above-described operation in real time during the operation of the robot 1. The above-described write function is the normal write function.

As the operation time of the robot 1 becomes longer, the volume of operational information S of the robot 1 increases enormously. Thus, the above-described configuration in which only the operational information S pertaining to a fixed time period is stored in the first memory 54 in real time is advantageous from the viewpoint of preventing large-sizing of the first memory 54, suppressing memory capacity increase, and reducing costs.

The second memory 55 is a storage device detachably attached to the information processing apparatus 3. The second memory 55 includes, for example, an SD card, a CD-ROM, or a USB memory. A user can detach the second memory 55, in which operational information S is stored, from the information processing apparatus 3, and for example, can reproduce and analyze the operational information S using another device.

In the present embodiment, the second memory 55 is not a constituent element of the information processing apparatus 3, but may be a constituent element thereof.

The third memory 56 is a storage device provided in or connectable to the information processing apparatus 3. The third memory 56 may be a volatile memory or a non-volatile memory. In addition, the third memory 56 may be detachable from the information processing apparatus 3.

The determination unit 53 determines whether a predetermined trigger condition has occurred. The “occurrence of a predetermined trigger condition” means that a condition for the writing unit 52 to perform the first write function or the second write function has been satisfied.

The occurrence of a trigger condition means that some error, that is, an abnormal situation, has occurred in the robot 1. In the present embodiment, each of the fact that the stress applied to the robot arm 10 exceeds a predetermined value (stress threshold value) and the fact that the velocity of the robot arm 10 exceeds a predetermined value (velocity threshold value) is a trigger condition. That is, when at least one of the two conditions that the stress applied to the robot arm 10 exceeds a predetermined value (stress threshold value) or the velocity of the robot arm 10 exceeds a predetermined value (velocity threshold value) is satisfied, the determination unit 53 determines that a predetermined trigger condition has occurred. In this case, the trigger condition occurs in three cases: when the stress applied to the robot arm 10 exceeds the predetermined value, when the velocity of the robot arm 10 exceeds the predetermined value, and when both of them exceed the respective predetermined values.

When the operational information S includes information other than stress information and velocity information, the predetermined trigger condition is appropriately set in accordance with the information other than stress information and velocity information. For example, when the operational information S is information of a captured image of the surroundings of the robot 1 captured by a separately installed camera, the predetermined trigger condition is that an intruding object is confirmed in the captured image of the surroundings of the robot 1. That is, when it is detected that any intruding object approaches the robot 1, a trigger signal is issued, and receiving this signal constitutes the trigger condition.

Furthermore, the predetermined trigger condition may be a condition that the user gives an instruction to perform writing to the second memory 55, in addition to or instead of the above conditions. The user can give an instruction to perform writing using, for example, the teaching apparatus 4 or the like.

Hereinafter, each write function will be described.

### First Write Function

When the determination unit 53 determines that a trigger condition has occurred, the writing unit 52 extracts first specific operational information S1 corresponding to the cause of the trigger condition from the operational information S stored in the first memory 54, and writes the first specific operational information S1 to the second memory 55. For example, when the stress applied to the robot arm 10 exceeds a predetermined value at a time T1, information including stress information, that is, the first specific operational information S1, of the operational information S stored in the first memory 54 is stored in the second memory 55 as illustrated in FIG. 4.

The first specific operational information S1 may be obtained by extracting only information corresponding to the cause of the trigger condition, or may include other information in addition to the information corresponding to the cause of the trigger condition.

In addition, the first specific operational information S1 includes operational information S pertaining to a predetermined time period (preceding time period BT1) before the time T1 at which the trigger condition occurred, and operational information S pertaining to a predetermined time period (subsequent time period AT1) after the time T1 at which the trigger condition occurred. That is, the first specific operational information S1 is operational information S pertaining to several seconds before and after the time T1 at which the trigger condition occurred. Accordingly, it is possible to store, in the second memory 55, the operational information S of the robot 1 before and after the time T1 at which the trigger condition occurred, and ascertain the behavior before and after the time T1 at which the trigger condition occurred.

The number of seconds of each of the preceding time period BT1 and the subsequent time period AT1 is not particularly limited, but the preceding time period BT1 is preferably greater than or equal to 2 seconds but less than or equal to 8 seconds, and the subsequent time period AT1 is preferably greater than or equal to 1 second but less than or equal to 2 seconds.

Furthermore, the ratio AT1/BT1 between the preceding time period BT1 and the subsequent time period AT1 is not particularly limited, but is preferably greater than or equal to 1 but less than or equal to 4.

At this time, the writing unit 52 subjects the first specific operational information S1 to a compression process (compression encoding process), and writes it to the second memory 55. Thus, the second memory 55 can store a sufficient amount of information.

### Second Write Function

When the determination unit 53 determines that another (new) trigger condition has occurred before the transmission unit 58 completes the transmission of the first specific operational information S1 to the outside of the second memory 55, which will be described later, the writing unit 52 extracts second specific operational information S2 corresponding to the cause of the other trigger condition from the operational information S and stores the second specific operational information S2 in the third memory 56. For example, when the stress applied to the robot arm 10 exceeds a predetermined value (stress threshold value) at a time T2 before the transmission unit 58 completes the transmission of the first specific operational information S1, which will be described later, information including stress information, that is, the second specific operational information S2, of the operational information S stored in the first memory 54 is extracted and stored in the third memory 56 as illustrated in FIG. 6.

The trigger condition for performing the second write function may be the same as or different from the trigger condition for performing the first write function.

The second specific operational information S2 may be obtained by extracting only information corresponding to the cause of the trigger condition, or may include other operational information S in addition to the information corresponding to the cause of the trigger condition.

In addition, the second specific operational information S2 includes operational information S pertaining to a predetermined time period (preceding time period BT2) before the time T2 at which the trigger condition occurred, and operational information S pertaining to a predetermined time period (subsequent time period AT2) after the time T2 at which the trigger condition occurred. That is, the second specific operational information S2 is operational information S pertaining to several seconds before and after the time T2 at which the trigger condition occurred. Accordingly, the operational information S of the robot 1 before and after the time T2 at which the trigger condition occurred can be stored in the third memory 56.

The time periods (BT2 and AT2) before and after the time T2 at which the trigger condition occurred in the second specific operational information S2 are respectively substantially equal to the time periods (BT1 and AT1) before and after the time T1 at which the trigger condition occurred in the first specific operational information S1. A preferred value of the ratio AT2/BT2 is also equal to that of the ratio AT1/BT1 described above.

However, the time periods (BT2 and AT2) before and after the time T2 at which the trigger condition occurred in the second specific operational information S2 are not limited to this configuration, and may be respectively different from the time periods (BT1 and AT1) before and after the time T1 at which the trigger condition occurred in the first specific operational information S1. Also, the ratio AT2/BT2 may be equal to or different from the ratio AT1/BT1.

### Third Write Function

As illustrated in FIG. 7, the writing unit 52 writes the second specific operational information S2 stored in the third memory 56 to the second memory 55, when the transmission unit 58 completes the transmission of the first specific operational information S1 to the outside of the second memory 55, which will be described later.

At this time, the second specific operational information S2 is subjected to a compression process and written to the second memory 55. Thus, the second memory 55 can store a sufficient amount of information.

As illustrated in FIG. 5, the transmission unit 58 has a function of transmitting the first specific operational information S1 stored in the second memory 55 to the outside of the second memory 55. The “outside of the second memory 55” is not particularly limited as long as it is other than the second memory 55. Examples thereof include a server (not illustrated), a client, another PC, a storage unit on the cloud, a USB memory, another memory, a hard disk, and a CD-ROM, and their installation locations are not particularly limited.

The transmission of the first specific operational information S1 to the “outside of the second memory 55” by the transmission unit 58 means storing backup data of the first specific operational information S1 in the “outside of the second memory 55”, that is, backing up the first specific operational information S1.

In this way, the first specific operational information S1 is also transmitted to and stored (backed up) in a location other than the second memory 55. Thus, the user can acquire the first specific operational information S1 from another storage device or the like outside the second memory 55 even when the data in the second memory 55 is damaged.

Note that even when the first specific operational information S1 is transmitted from the second memory 55 to the outside of the second memory 55, the first specific operational information S1 remains in the second memory 55 as it is.

Hereinafter, the “outside of the second memory 55”, which is the transmission target of the transmission unit 58, is described as the server 200.

A transmission path (transmission method) to the server 200 used by the transmission unit 58 may be wired, wireless, or a combination thereof. Transmission may also be performed via a network such as the Internet.

The first specific operational information S1 to be transmitted to the server 200 may be encrypted. In this case, since the encryption process requires time, the total transmission time, including the encryption process, may be increased, whereas there is an advantage that higher security is ensured. The increased transmission time is sufficiently compensated for by the effects of the present disclosure described later, making the application of the present disclosure highly advantageous.

The backup request signal acquisition unit 57 acquires a signal of a backup request (hereinafter, referred to as a “backup request signal”) from the user. The backup request signal can be input and output by the user using the teaching apparatus 4 or the like, for example. In FIGS. 5 and 6, it is assumed that backup is started at a time T3.

Upon acquiring the backup request signal, the transmission unit 58 transmits the first specific operational information S1 to the outside of the second memory 55 at this timing. The transmission unit 58 may transmit the first specific operational information S1 to the outside of the second memory 55 at a predetermined timing.

The backup request signal is not limited to being issued in response to the user's instruction as described above, and may be, for example, issued automatically or in accordance with a predetermined rule (algorithm) inside or outside the information processing apparatus 3 without user involvement. As an example of the rule, the necessity of a backup is determined in consideration of various conditions such as the type, importance, and occurrence time of a trigger condition, and output or non-output of the backup request signal is selected and executed in accordance with the determination result.

The backup of the first specific operational information S1 may take a relatively long time depending on the data volume, the presence or absence of an encryption process, the data transmission method, and the like. When the second specific operational information S2 is directly written from the first memory 54 to the second memory 55 immediately after another trigger condition occurs during the backup of the first specific operational information S1, the writing process of the second specific operational information S2 by the writing unit 52 and the backup process by the transmission unit 58 are performed simultaneously. In this case, a load is applied to the processor that performs each process, and the time required for each process further increases. In some cases, before writing of the second specific operational information S2 is started, the second specific operational information S2 in the first memory 54 may be overwritten with the next operational information S, so that the second specific operational information S2 cannot be written to the second memory 55.

To address this problem, in the information processing apparatus 3, when another trigger condition occurs while the transmission unit 58 is transmitting the first specific operational information S1, the writing unit 52 temporarily writes the second specific operational information S2 to the third memory 56, and saves the second specific operational information S2 to prevent it from being overwritten with new operational information S. Then, when the transmission unit 58 completes transmission of the first specific operational information S1, the writing unit 52 writes the second specific operational information S2 saved in the third memory 56 to the second memory 55 as illustrated in FIG. 7.

With such a configuration, even when trigger conditions frequently occur (multiple times) in a short time, it is possible to prevent or suppress the inconvenience of the second specific operational information S2 being overwritten and deleted or part of the data being damaged regardless of the timing of backup. Therefore, even when trigger conditions frequently occur in a short time, it is possible to accurately store the operational information S corresponding to the cause of each trigger condition in the second memory 55 regardless of the timing of backup.

In the present embodiment, when the second specific operational information S2 stored in the third memory 56 is written to the second memory 55, the second specific operational information S2 is also transmitted to the outside of the second memory 55 in response to a backup request signal, similarly to the first specific operational information S1, as indicated by a one-dot chain line in FIG. 7. In this case, upon acquiring the backup request signal, the transmission unit 58 transmits the second specific operational information S2 to the outside of the second memory 55 either immediately or when a predetermined time period has elapsed. The same operations as described above, that is, the backup operation of the first specific operational information S1 and the subsequent writing operation of the second specific operational information S2 from the third memory 56 to the second memory 55 are also performed, when another trigger condition (corresponding to third specific operational information) occurs before the transmission of the second specific operational information S2 is completed, that is, during the backup of the second specific operational information S2.

As described above, the information processing apparatus 3 includes the first memory 54 that stores operational information S pertaining to a fixed time period in real time while the robot 1 having the robot arm 10 is operating; the determination unit 53 that determines whether a predetermined trigger condition occurs; the writing unit 52 that, when the determination unit 53 determines that the trigger condition occurs, extracts first specific operational information S1 corresponding to a cause of the trigger condition from the operational information S stored in the first memory 54 and writes the first specific operational information S1 to the second memory 55; the transmission unit 58 that transmits the first specific operational information S1 stored in the second memory 55 to the outside of the second memory 55 (to the server 200); and the third memory 56 that, when the determination unit 53 determines that another trigger condition occurs before the transmission unit 58 completes transmission of the first specific operational information S1, stores second specific operational information S2 extracted from the operational information S by the writing unit 52, the second specific operational information S2 corresponding to a cause of the other trigger condition. The writing unit 52 writes the second specific operational information S2 stored in the third memory 56 to the second memory 55 after the transmission unit 58 completes transmission of the first specific operational information S1. Accordingly, even when trigger conditions occur frequently in a short time, the first specific operational information S1 and the second specific operational information S2 can be accurately stored in the second memory 55 regardless of the timing at which the transmission unit 58 transmits the first specific operational information S1 to the outside of the second memory 55.

Furthermore, the robot system 100 includes the robot 1 having the robot arm 10 and the information processing apparatus 3 that processes operational information S of the robot 1. The information processing apparatus 3 includes the first memory 54 that stores operational information S pertaining to a fixed time period in real time; the determination unit 53 that determines whether a predetermined trigger condition occurs; the writing unit 52 that, when the determination unit 53 determines that the trigger condition occurs, extracts first specific operational information S1 corresponding to a cause of the trigger condition from the operational information S stored in the first memory 54 and writes the first specific operational information S1 to the second memory 55; the transmission unit 58 that transmits the first specific operational information S1 stored in the second memory 55 to the outside of the second memory 55 (to the server 200); and the third memory 56 that, when the determination unit 53 determines that another trigger condition occurs before the transmission unit 58 completes transmission of the first specific operational information S1, stores second specific operational information S2 extracted from the operational information S by the writing unit 52, the second specific operational information S2 corresponding to a cause of the other trigger condition. The writing unit 52 writes the second specific operational information S2 stored in the third memory 56 to the second memory 55, after the transmission unit 58 completes transmission of the first specific operational information S1. Accordingly, even when trigger conditions occur frequently in a short time, the first specific operational information S1 and the second specific operational information S2 can be accurately stored in the second memory 55 regardless of the timing at which the transmission unit 58 transmits the first specific operational information S1 to the outside of the second memory 55. Therefore, it is possible to, for example, more effectively analyze the behavior of the robot arm 10 before and after the occurrence of a trigger condition, the cause of the trigger condition and the like, thereby allowing this analysis to be reflected in the subsequent appropriate operations of the robot arm 10.

Note that the writing unit 52 may be configured to write the second specific operational information S2 stored in the third memory 56 to the second memory 55 immediately after the transmission unit 58 completes transmission of the first specific operational information S1. Alternatively, the writing unit 52 may be configured to write the second specific operational information S2 stored in the third memory 56 to the second memory 55 when a predetermined time period elapses after the transmission unit 58 completes transmission of the first specific operational information S1.

When another trigger condition occurs while the second specific operational information S2 stored in the third memory 56 is being written to the second memory 55, it is preferable to extract third specific operational information corresponding to the cause of the other trigger condition from the operational information S and write it to the third memory 56.

As described above, when writing the second specific operational information S2 stored in the third memory 56 to the second memory 55, the writing unit 52 compresses data constituting the second specific operational information S2 and writes it to the second memory 55. Accordingly, it is possible to rapidly perform the writing process and thus more effectively shorten the time required to store the second specific operational information S2 in the second memory 55. This can shorten the time required to complete the writing of the second specific operational information S2 to the second memory 55. Further, the second memory 55 can store a sufficient amount of information.

Note that when writing the second specific operational information S2 stored in the third memory 56 to the second memory 55, the writing unit 52 may write the second specific operational information S2 to the second memory 55 without compressing data constituting the second specific operational information S2.

The operational information S includes at least one of (in the present embodiment, both of) stress information regarding the stress applied to the robot arm 10 and velocity information regarding the velocity of the robot arm 10. This enables accurate storage of highly important stress information and velocity information.

Note that the operational information S may include only one of stress information and velocity information.

Also, the operational information S may include information other than stress information and velocity information, or may include only information other than stress information and velocity information without including any stress information and velocity information. Information other than stress information and velocity information is as described above.

In a case where the operational information S includes stress information, the determination unit 53 determines that a trigger condition has occurred, when the stress exceeds a predetermined value (stress threshold value). In a case where the operational information S includes velocity information, the determination unit 53 determines that a trigger condition has occurred, when the velocity exceeds a predetermined value (velocity threshold value). This allows accurate storage of necessary information.

Each of the first specific operational information S1 and the second specific operational information S2 includes operational information S pertaining to a predetermined time period (preceding time period BT1 or BT2) before the time T1 or T2 at which a trigger condition occurred, and operational information S pertaining to a predetermined time period (subsequent time period AT1 or AT2) after the time T1 or T2 at which the trigger condition occurred. Accordingly, it is possible to store, in the second memory 55, the operational information S of the robot 1 before and after the times T1 and T2 at which the trigger conditions occurred, and ascertain the behavior of the robot arm 10 before and after the times T1 and T2 at which the trigger conditions occurred. In particular, the behavior can be analyzed in more detail and more effectively. The result of the analysis can be reflected in the subsequent appropriate operations of the robot arm 10.

Each of the first specific operational information S1 and the second specific operational information S2 may include only the operational information S pertaining to a predetermined time period (preceding time period BT1 or BT2) before the time T1 or T2 at which the trigger condition occurred, may include only the operational information S pertaining to a predetermined time period (subsequent time period AT1 or AT2) after the time T1 or T2 at which the trigger condition occurred, or may include only the operational information S pertaining to the time T1 or T2 at which the trigger condition occurred.

The robot system 100 may include a notification unit that notifies the occurrence of a trigger condition, the occurrence of a trigger condition and the cause thereof, the execution of writing of the first specific operational information S1 to the second memory 55, the execution of writing of the second specific operational information S2 to the third memory 56, the execution of data transmission to the outside of the second memory 55 by the transmission unit 58, the execution of writing of the second specific operational information S2 from the third memory 56 to the second memory 55, and the like. Examples of the notification unit include the above-described display unit 40, and it is possible to perform notification by displaying each of the above-described notifications on the display unit 40 using characters, graphics, or the like. In addition, although not illustrated, the information processing apparatus 3 may include a display unit similar to the display unit 40, and the display unit may notify each of the above-described notifications.

Next, an example of the information processing apparatus and the information processing method according to the present disclosure will be described with reference to a flowchart illustrated in FIG. 8.

First, in step S100, operational information S pertaining to a fixed time period is stored in real time in a state where the robot arm 10 is operating. That is, the operational information acquisition unit 51 acquires the operational information S from the robot 1, and the writing unit 52 writes the acquired operational information S to the first memory 54. Step S100 is the first step.

Next, in step S101, it is determined whether a predetermined trigger condition has occurred. Step S101 is the second step. The determination in this step is performed by the determination unit 53 as described above.

When it is determined in step S101 that a predetermined trigger condition has occurred (step S101: YES), the process proceeds to step S102. When it is determined in step S101 that no trigger condition has occurred (step S101: NO), the process proceeds to step S106.

In step S102, writing of first specific operational information S1 to the second memory 55 is started. That is, the writing unit 52 extracts the first specific operational information S1 corresponding to the cause of the trigger condition from the operational information S stored in the first memory 54, and starts writing of the first specific operational information S1 to the second memory 55. Step S102 is the third step.

Next, in step S103, it is determined whether a backup request has been made. The determination in this step is performed on the basis of whether the backup request signal acquisition unit 57 has acquired a backup request signal.

When it is determined in step S103 that a backup request has been made (step S103: YES), the backup is started in step S103A. That is, the transmission unit 58 transmits the first specific operational information S1 stored in the second memory 55 to the server 200. Step S103A is the fourth step.

On the other hand, when it is determined in step S103 that no backup request has been made (step S103: NO), the process proceeds to step S105.

Next, in step S104, it is determined whether a trigger condition has occurred during the backup (until the transmission to the server 200 is completed). That is, it is determined whether another (new) trigger condition has occurred while the transmission unit 58 is transmitting the first specific operational information S1 to the server 200. The determination in this step is performed by the determination unit 53 as described above.

When it is determined in step S104 that a trigger condition has occurred (step S104: YES), the process proceeds to step S107. When it is determined in step S104 that no trigger condition has occurred (step S104: NO), the process proceeds to step S105.

In step S105, it is determined whether writing of the first specific operational information S1 to the second memory 55 has been completed. In step S105, when it is determined that the writing has been completed (step S105: YES), the process proceeds to step S106, and when it is determined that the writing has not been completed (step S105: NO), the process returns to step S104.

On the other hand, when it is determined in step S104 that a trigger condition has occurred, it indicates that another trigger condition has occurred during the backup. In this case, in step S107, second specific operational information S2 corresponding to the cause of the trigger condition is extracted from the operational information S in the first memory 54 and written to the third memory 56. Step S107 is the fifth step. The writing in this step is performed by the writing unit 52 as described above.

Next, when the backup has been completed, the second specific operational information S2 stored in the third memory 56 is then written to the second memory 55 in step S108. Step S108 is the sixth step. The writing in this step is performed by the writing unit 52 as described above.

Next, in step S106, it is determined whether the operation of the robot 1, that is, the operation of the robot arm 10, has ended. When it is determined in step S106 that the operation of the robot 1 has ended, the program ends. When it is determined in step S106 that the operation of the robot 1 has not ended, the process returns to step S100.

As described above, the information processing method includes the first step of writing operational information S pertaining to a fixed time period of the robot 1 having the robot arm 10 to the first memory 54 that stores the operational information S in real time; the second step of determining whether a predetermined trigger condition occurs; the third step of, when it is determined in the second step that the trigger condition occurs, writing first specific operational information S1 corresponding to a cause of the trigger condition, of the operational information S stored in the first memory 54, to the second memory 55; the fourth step of transmitting the first specific operational information S1 stored in the second memory 55 to the outside of the second memory 55 (to the server 200); the fifth step of, when another trigger condition occurs before transmission of the first specific operational information S1 in the fourth step is completed, extracting second specific operational information S2 corresponding to a cause of the other trigger condition from the operational information S and storing the second specific operational information S2 in the third memory 56; and the sixth step of writing the second specific operational information S2 stored in the third memory 56 to the second memory 55 after transmission of the first specific operational information S1 is completed. As a result, even when trigger conditions frequently occur in a short time, the first specific operational information S1 and the second specific operational information S2 corresponding to those trigger conditions can be accurately and quickly stored in the second memory 55. Therefore, it is possible to, for example, more effectively analyze the behavior of the robot arm 10 before and after the occurrence of a trigger condition, the cause of the trigger condition, and the like, and reflect the analysis in the subsequent appropriate operations of the robot arm 10.

A program for executing the information processing method of the present disclosure is stored in the storage unit 32 of the information processing apparatus 3. However, the program is not limited to this configuration, and may be stored in the storage unit 42 of the teaching apparatus 4 or may be stored in another storage device.

While the illustrated embodiments of the information processing apparatus, the robot system, and the information processing method of the present disclosure have been described above, the present disclosure is not limited thereto. Furthermore, each unit and each process of the information processing apparatus, the robot system, and the information processing method can be replaced with any structure or process that can exhibit the same function. Additionally, any structure or process may be added.

1. An information processing apparatus comprising:
a first memory that stores operational information pertaining to a fixed time period in real time while a robot having a robot arm is operating;
a determination unit that determines whether a predetermined trigger condition occurs;
a writing unit that, when the determination unit determines that the trigger condition occurs, extracts first specific operational information corresponding to a cause of the trigger condition from the operational information stored in the first memory, and writes the first specific operational information to a second memory;
a transmission unit that transmits the first specific operational information stored in the second memory to outside of the second memory; and
a third memory that, when the determination unit determines that another trigger condition occurs before the transmission unit completes transmission of the first specific operational information, stores second specific operational information extracted from the operational information by the writing unit, the second specific operational information corresponding to a cause of the other trigger condition,
wherein the writing unit writes the second specific operational information stored in the third memory to the second memory after the transmission unit completes transmission of the first specific operational information.

2. The information processing apparatus according to claim 1, wherein
when writing the second specific operational information stored in the third memory to the second memory, the writing unit compresses data constituting the second specific operational information and writes the compressed data to the second memory.

3. The information processing apparatus according to claim 1, wherein
the operational information includes at least one of stress information regarding a stress applied to the robot arm and velocity information regarding a velocity of the robot arm.

4. The information processing apparatus according to claim 3, wherein
in a case where the operational information includes the stress information, the determination unit determines that the trigger condition occurs when the stress exceeds a predetermined value, and
in a case where the operational information includes the velocity information, the determination unit determines that the trigger condition occurs when the velocity exceeds a predetermined value.

5. The information processing apparatus according to claim 1, wherein
the first specific operational information includes operational information pertaining to a predetermined time period before a time at which the trigger condition occurs, and operational information pertaining to a predetermined time period after the time at which the trigger condition occurs, and
the second specific operational information includes operational information pertaining to a predetermined time period before a time at which the other trigger condition occurs, and operational information pertaining to a predetermined time period after the time at which the other trigger condition occurs.

6. A robot system comprising:
a robot having a robot arm; and
an information processing apparatus that processes operational information of the robot,
the information processing apparatus including:
a first memory that stores operational information pertaining to a fixed time period in real time;
a determination unit that determines whether a predetermined trigger condition occurs;
a writing unit that, when the determination unit determines that the trigger condition occurs, extracts first specific operational information corresponding to a cause of the trigger condition from the operational information stored in the first memory, and writes the first specific operational information to a second memory;
a transmission unit that transmits the first specific operational information stored in the second memory to outside of the second memory; and
a third memory that, when the determination unit determines that another trigger condition occurs before the transmission unit completes transmission of the first specific operational information, stores second specific operational information extracted from the operational information by the writing unit, the second specific operational information corresponding to a cause of the other trigger condition,
wherein the writing unit writes the second specific operational information stored in the third memory to the second memory after the transmission unit completes transmission of the first specific operational information.

7. An information processing method comprising:
a first step of writing operational information pertaining to a fixed time period of a robot having a robot arm to a first memory that stores the operational information in real time;
a second step of determining whether a predetermined trigger condition occurs;
a third step of, when it is determined in the second step that the trigger condition occurs, writing first specific operational information corresponding to a cause of the trigger condition, of the operational information stored in the first memory, to a second memory;
a fourth step of transmitting the first specific operational information stored in the second memory to outside of the second memory;
a fifth step of, when another trigger condition occurs before transmission of the first specific operational information in the fourth step is completed, extracting second specific operational information corresponding to a cause of the other trigger condition from the operational information and storing the second specific operational information in a third memory; and
a sixth step of writing the second specific operational information stored in the third memory to the second memory after transmission of the first specific operational information is completed.
